(19) United States
(12) Patent Application Publication
(10) Pub. No.: US 2026/0011270 A1
(43) Pub. Date: Jan. 8, 2026

(54) Battery-Operated Traffic Control Device

(71) Applicant: James Urbano, Woodbridge, CT (US)

(72) Inventor: James Urbano, Woodbridge, CT (US)

(21) Appl. No.: 18/793,138

(22) Filed: Aug. 2, 2024

Related U.S. Application Data
(60) Provisional application No. 63/517,139, filed on Aug. 2, 2023.

(51) Int. Cl. G09F 9/33; E01F 9/615

(52) U.S. Cl. CPC G09F 9/33; E01F 9/617

(57) ABSTRACT

A traffic control device is provided comprising a shaft; a signboard affixed to an upper end of the shaft, the signboard having two faces, including: a first face configured to display a first set of indicia via LEDs and comprising a first set of led signal lights; and a second face configured to display a second set of indicia via LEDs and comprising a second set of LED signal lights. The device also includes a removable and rechargeable battery being affixed to a battery connector at a base of the shaft. The first set of indicia may include the word “STOP” in red LEDs, and the first set of LED signal lights may be red. The second set of indicia may include the word “GO” in yellow LEDs, and the second set of LED signal lights may include yellow LED signal lights.

### FIELD OF THE INVENTION

The present application relates to a traffic control device that can control traffic more safely than existing unlit two-sided signs now commonly in use, which are less visible to drivers.

### BACKGROUND OF THE DISCLOSURE

The present application relates of a traffic control device or tool that more safely controls traffic than existing hand-held and staff-mounted signs now commonly in use, with unique features that will enable broader use, therefore promoting greater traffic control safety.

According to the National Safety Council, there were 42,151 roadside work zone injuries and nearly 1,000 deaths in 2021. Thus, there is an urgent need for safety improvement.

With present devices, bright sunlight or shade from trees or structures tend to wash out the sign text or the signaler's hand motions. While high-intensity LED lighting will cause the “STOP” or “GO” directives to be far more visible, the means of power is a shortcoming of the present generation of hand-held LED-lit traffic control signs.

The deficiency of the present staff-mounted LED-lit traffic control signs is the common use of built-in rechargeable batteries of the sign-maker's design, which require taking the sign out of service in order to recharge.

### SUMMARY OF THE DISCLOSURE

The present application seeks to provide a traffic control device addressing these shortcomings in the art.

The traffic control device of the present application can be used, for example, where roadside work or a stranded vehicle impinges on the travel lane, requiring a flagman to warn oncoming traffic with clear and visible instructions. For example, the device can signal to an oncoming driver to “STOP” and flash red LED (light emitting diode) lights, while concurrently signaling to opposing traffic to “GO” cautiously, flashing yellow LED lights.

The tool includes a two-sided octagonal sign mounted on a staff. The lettering can be formed with high intensity LED bulbs, which in some embodiments can be colored red on the “STOP” side and green on the “GO” opposite side. The sign may also comprise yellow flashing lights above the “GO” indicia, to signify that the driver should proceed with caution. Each side of the sign may comprise a pair of flashing LED lights, or other types of lights, at least four inches in diameter, colored red on the stop side, and yellow on the “GO” cautiously side. The LED lights may be shaded, including a shade projecting outward from the sign over each light, to keep the light in the shade for visibility.

The traffic control device can be reversed manually by rotating the staff and sign 180 degrees, or the traffic control device can have a motorized rotation controlled by a staff mounted switch. In further embodiments, the “STOP and “GO” signals are overlaid on both faces, so that switching from one mode to the other does not require rotating the sign.

A unique feature of the device of the present application is the use of an existing rechargeable battery mass-produced by one of the existing cordless tool makers. The traffic control device would be a unique tool that can be added to a manufacturer's line of cordless tools.

Presently, none of the cordless tool manufacturers include a traffic control device with their respective lines of cordless rechargeable battery tools. Utilizing a cordless tool manufacturers' battery for the traffic control device is a unique application. The traffic control device of the present application presents this novel use of a commonly used cordless tool battery.

Another unique design feature of the traffic control device of the present application, is the placement of the rechargeable battery at the base of the sign's staff or shaft. The rechargeable and interchangeable battery is the tool's “foot”, with its weight bearing on the road surface, lending stability to the tool, and alleviating operator fatigue. A depleted battery could swiftly be exchanged for a charged battery, without loss of service.

The present application relates to a traffic control device comprising a shaft; a signboard affixed to an upper end of the shaft, the signboard having two faces, including: a first face configured to display a first set of indicia via LEDs and comprising a first set of led signal lights; and a second face configured to display a second set of indicia via LEDs and comprising a second set of LED signal lights. The device also includes a removable and rechargeable battery being affixed to a battery connector at a base of the shaft.

In aspects of the traffic control device, the first set of indicia on the first face may include the word “stop” in red LEDs, and the first set of LED signal lights on the first face may include red LED signal lights. The second set of indicia on the second face may include the word “go” in yellow LEDs, and the second set of LED signal lights on the second face may include yellow LED signal lights.

The traffic control device may include a mechanical rotor configured to rotate the shaft 180 degrees upon activation of a switch.

The first set of LED signal lights and the second set of LED signal lights each may include two LED signal lights. The first set of LED signal lights and the second set of LED signal lights may each be configured to flash.

The first set of LED signal lights and the second set of LED signal lights each may include one or more shades arranged over the LED signal lights to block sunlight. The first set of indicia and the second set of indicia each may include one or more shades arranged over the indicia to block sunlight.

The removable and rechargeable battery is a battery configured for separate use with a compatible power tool. The removable and rechargeable battery may also be the base of the traffic control device, and the shaft and signboard are configured to rest thereon.

The first face can be configured to change displayed text in first set of indicia between two messages in an alternating manner, and the second face can be configured to change displayed text in the second set of indicia in the alternating manner. The traffic control device may include a switch configured to change the displayed text in each of the first set of indicia and the second set of indicia.

The traffic control device may have a height of at least eight feet.

### BRIEF DESCRIPTION OF THE FIGURES

FIG. 1 shows a first view of a traffic control device of the present application;

FIG. 2 shows a second view of the traffic control device of FIG. 1; and

FIGS. 3a and 3b show further views of a traffic control device of the present application.

### DETAILED DESCRIPTION OF THE FIGURES

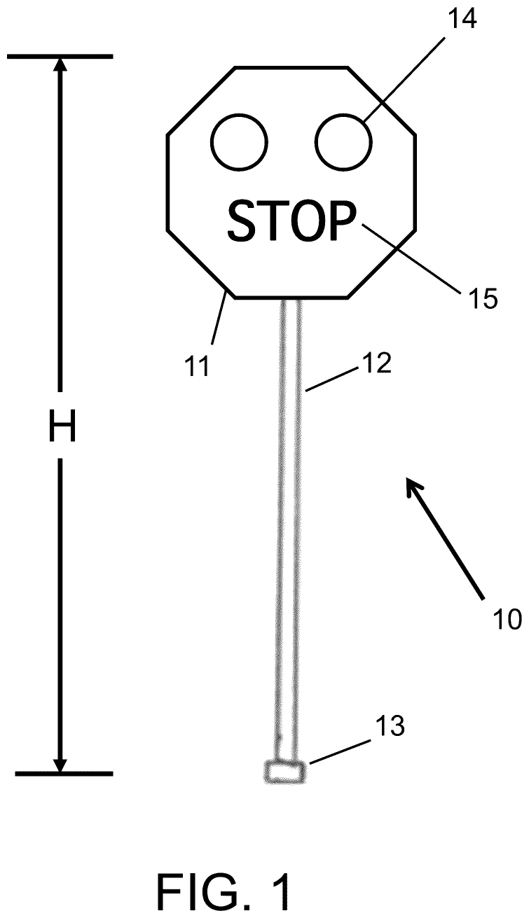

A traffic control device 10 of the present application will now be described with reference to FIGS. 1-2, 3a and 3b.

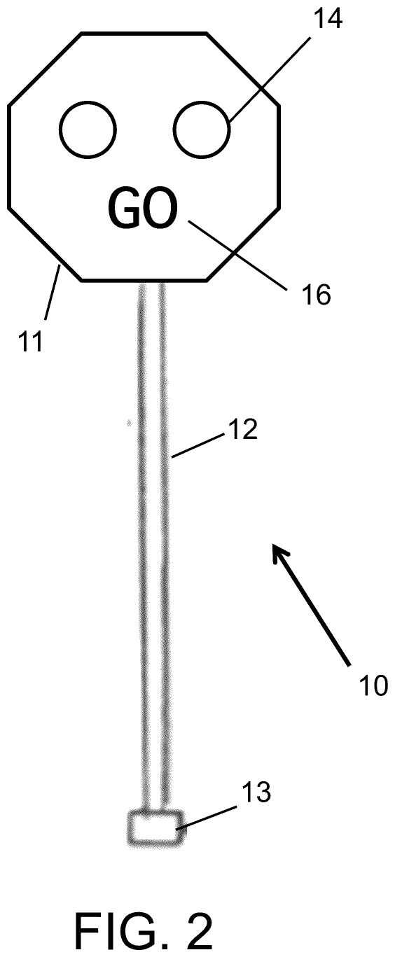

The device 10 includes a two-sided signboard 11 mounted on a shaft 12. FIG. 1 of the application shows a view of the device from a first side of the sign 11, and FIG. 2 shows the device from the second side of the signboard 11. One side of the signboard 11, shown for example in FIG. 1, can be considered the “STOP” side of the signboard 11, and the other side shown in FIG. 2 can be considered the “GO” side of the signboard 11. Each side of the signboard 11 comprises lettering 15, 16, or other indicia such as symbols or other characters, to convey a message to drivers and others in view of the device 10. The lettering 15, 16 can be formed with high intensity LED bulbs to improve their visibility. In the embodiments shown in FIGS. 1 and 2, the lettering 15 on the “STOP” side of the signboard 11 can include the word “STOP” colored red, and the lettering 16 on the “GO” side can include the word “GO” colored green or yellow. Alternative wording and coloring can be provided, such as “SLOW” in yellow, or other non-text symbols can be presented having similar meanings.

Each side of the signboard 11 also may comprise would have a pair of (or more) flashing LED lights 14. The flashing LED lights 14 can be at least four inches in diameter and may vary in color depending on the purpose of the light. For example, the flashing LED lights 14 can be colored red on the “STOP” side, and colored yellow or green on the “GO” side. The face of the signboard 11 on each side may comprise shades that extend outwardly and over the LED lights 14, to aid in their visibility in high sun environments. Shades may similarly be provided over the lettering 15, 16.

The device 10 as shown in FIGS. 1 and 2 can be reversed manually by rotating the staff 12 and attached signboard 11 180 degrees, or the shaft 12 can be rotated mechanically by including a motorized rotor (not shown) for the shaft 12, which can be controlled by switch mounted on the shaft 12, or by a remote controller.

The device 10 is configured to be powered by a removable and rechargeable battery 13. The battery 13 is preferably a removeable battery of the kind used in power tools, such as those manufactured by a tool company for use with their line of tools (including but not limited to DEWALT, MAKITA, BOSCH, MILWAUKEE, or RYOBI, and others). The device 10 comprises a battery connector (not shown), which is configured to correspond to the receiving end connector of a cordless battery having a pre-defined connector. In the embodiments illustrated in the Figure, the battery connector of the device 10 is located at the base of the shaft 12. The battery 13 serves as “foot” of the device 10, with its weight bearing on the road surface. By having the battery 13 serve as the base of the device 10, it lends stability to the device 10 and alleviates operator fatigue. A depleted battery 13 could swiftly be exchanged for a charged battery 13, without loss of service.

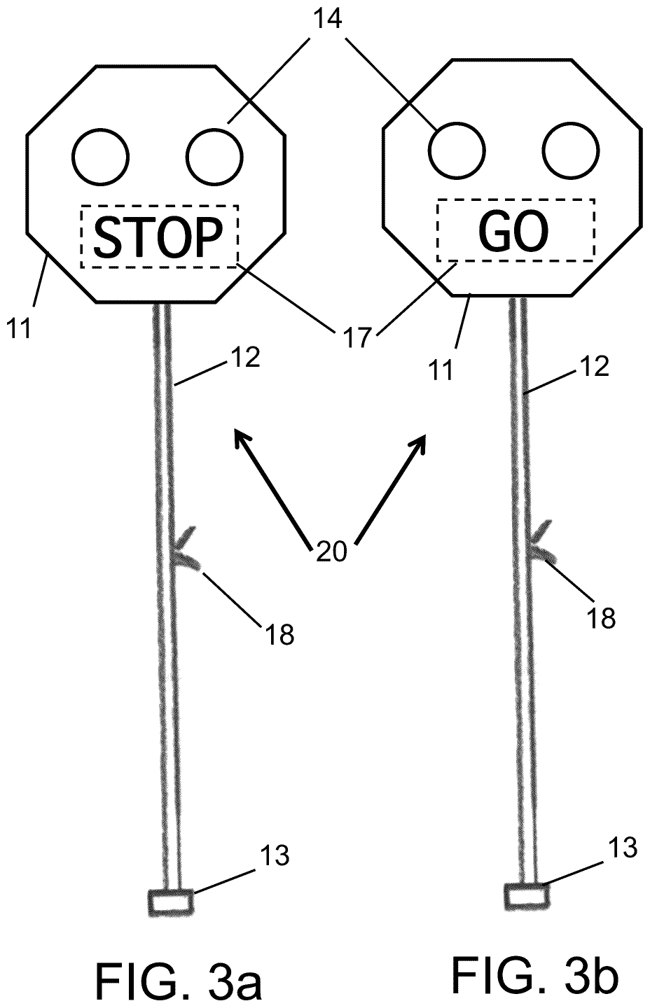

A further embodiment of the device 20 is shown in FIGS. 3a and 3b. In the device 20, each face of the signboard 11 comprises an LED face 17, which can be programed to display certain text, lettering, or other indicia. Thus, in operation, the LED face 17 of the device 20 is configured to be able to display the text “STOP and “GO” signals on both faces, and a switch 18 can be provided on the shaft 12 or remotely to allow switching from one mode to the other without needing to rotate the sign (FIGS. 3a and 3b). Alternatively, the face 17 may comprise two sets of indicia overlaid, one for the word “STOP” and one for the word “GO” and the two indicia can be alternated between using the switch 18. The switch 18 may also be configured to change the color of the LED lights 14 to the appropriate context.

In the embodiments of the traffic control device 10, 20 shown in the Figures, the device may have a height (H) of approximately eight feet, but in other embodiments the height can vary.

While showing and describing the fundamental novel features of the invention, it is understood that various omissions and substitutions and changes in the form and details of the devices and methods described may be made by those skilled in the art without departing from the spirit of the invention. For example, it is expressly intended that all combinations of those elements and/or methods which perform substantially the same function in substantially the same way to achieve the same results are within the scope of the invention. Moreover, it should be recognized that structures and/or elements and/or methods shown or described in connection with any disclosed form or embodiment of the invention may be incorporated in any other disclosed or described or suggested form or embodiment as a general matter of design choice.

What is claimed:

1. A traffic control device comprising:
a shaft;
a signboard affixed to an upper end of the shaft, the signboard having two faces, including:
a first face configured to display a first set of indicia via LEDs and comprising a first set of LED signal lights; and
a second face configured to display a second set of indicia via LEDs and comprising a second set of LED signal lights; and
a removable and rechargeable battery being affixed to a battery connector at a base of the shaft.

2. The traffic control device of claim 1, wherein the first set of indicia on the first face comprises the word “STOP” in red LEDs, and the first set of LED signal lights on the first face comprise red LED signal lights.

3. The traffic control device of claim 2, wherein the second set of indicia on the second face comprises the word “GO” in yellow LEDs, and the second set of LED signal lights on the second face comprise yellow LED signal lights.

4. The traffic control device of claim 1, wherein the first set of LED signal lights and the second set of LED signal lights each comprise two LED signal lights.

5. The traffic control device of claim 1, wherein the first set of LED signal lights and the second set of LED signal lights each are configured to flash.

6. The traffic control device of claim 1, wherein the first set of LED signal lights and the second set of LED signal lights each comprise one or more shades arranged over the LED signal lights to block sunlight.

7. The traffic control device of claim 1, wherein the first set of indicia and the second set of indicia each comprise one or more shades arranged over the indicia to block sunlight.

8. The traffic control device of claim 3, further comprising a mechanical rotor configured to rotate the shaft 180 degrees upon activation of a switch.

9. The traffic control device of claim 1, wherein the removable and rechargeable battery is a battery configured for separate use with a compatible power tool.

10. The traffic control device of claim 1, wherein the removable and rechargeable battery is the base of the traffic control device, and the shaft and signboard are configured to rest thereon.

11. The traffic control device of claim 1, wherein the first face is configured to change displayed text in first set of indicia between two messages in an alternating manner, and wherein the second face is configured to change displayed text in the second set of indicia in the alternating manner.

12. The traffic control device of claim 11, further comprising a switch configured to change the displayed text in each of the first set of indicia and the second set of indicia.

13. The traffic control device of claim 1, wherein the traffic control device has a height of at least eight feet.
